(19) United States
(12) Patent Application Publication
(10) Pub. No.: US 2025/0092620 A1
(43) Pub. Date: Mar. 20, 2025

(54) ROBOTIC SYSTEM FOR FLOOR MARKING

(71) Applicant: KING FAHD UNIVERSITY OF PETROLEUM AND MINERALS, Dhahran (SA)

(72) Inventors: Fatimah Abdullah ALAHMED, Dhahran (SA); Uthman BAROUDI, Dhahran (SA); Muhammad HAWWA, Dhahran (SA)

(73) Assignee: KING FAHD UNIVERSITY OF PETROLEUM AND MINERALS, Dhahran (SA)

(21) Appl. No.: 18/467,131

(22) Filed: Sep. 14, 2023

(51) Int. Cl. E01C 23/16; B25J 5/00; B25J 11/00

(52) U.S. Cl. CPC E01C 23/163; B25J 5/007; B25J 11/0075

(57) ABSTRACT

A robotic system for surface marking comprises a plotter configured to move along x, y and z axes; a chassis configured to hold a plurality of components of the robotic system; one or more ultrasonic sensors mounted on a periphery of the chassis and configured to detect obstacles during movement of the robotic system; at least three drive members coupled to a motor unit configured to control the movement of the robotic system on a surface; and a computer processor having program instructions for controlling the robotic system. The movement of the robotic system is controlled with the computer processor so as to move the plotter and form a marking on the surface based on a pre-determined surface marking stored in a memory of the computer processor.

### STATEMENT OF PRIOR DISCLOSURE BY AN INVENTOR

Aspects of the present disclosure were described in “A system for 2D and 3D crafting and marking” Fatimah Abdullah Alahmed, Thesis, King Fahd University of Petroleum & Minerals Collage of Computer Sciences and Engineering Department of Computer Engineering, which is incorporated herein by reference in its entirety.

### BACKGROUND

### Technical Field

The present disclosure relates to a robotic system, device, and method for surface marking, and more particularly, to a robotic system, device and method including a plotter positioned on an autonomous wheeled robot designed for 2D and 3D surface marking.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

Signage is a visual method of communication. Surface marking is a popular kind of signage. The surface marking, particularly on floors, has been an integral aspect of numerous industries for decades. From demarcating specific zones in a warehouse to creating pathways in public spaces or even laying out sports courts, surface markings provide clarity, direction, and organization. These surface markings are not merely ornamental, but serve critical functional roles. The surface markings serve as visual cues, guiding individuals, and ensuring safety and efficiency in spaces where precision and order are paramount. For instance, it is important to mark the roads with dashed lines and signs to ensure the safety of traffic. Similarly, in industry, it is important to mark the area around contaminations to keep people informed to stay away, as per requirement of Occupational Safety and Health Administration (OSHA) standards. The construction sites are also required to mark the ground for installing the walls. Further, the surface markings are used for instructing people in large building, e.g., on the floor to define direction to emergency exit.

While the surface markings themselves are of importance, the methods employed to lay out such markings have many challenges. Traditional methods primarily involved manual labor, where individuals would use tools and paints to create markings based on predefined designs. Such manual methods, while effective to a degree, are time-consuming, labor-intensive, and often lacked the precision that certain applications demanded. Sometimes, individuals tend to use stickers instead of paint to simplify the process. However, the use of tape can be dangerous in hazardous settings, such as laboratories. The reason is that the stickers can peel-off and accumulate dirt, and may even cause the fall of people. Besides, removing tapes may the affect the back of workers.

Some attempts at automating the surface marking process have been made involved creating machines with predefined paths, where the device would follow a set pattern to create markings. Others have used guides or rails to ensure straight lines. However, these methods, while innovative, have their own set of limitations. Machines with predefined paths lack flexibility. If there was a need to change the design or if the machine encountered an obstacle, manual intervention is required. Machines using guides or rails, on the other hand, are limited in their applications. Such machines may be suitable for straight lines but lack the versatility needed for intricate designs.

In recent years, with the rise of robotics, there have been efforts to integrate robotic technology into surface marking. Robots, by their very nature, bring in a high degree of precision, flexibility, and automation. Some robotic systems have been designed to move autonomously, equipped with sensors to detect, and navigate around obstacles. Others have been programmed with complex instructions, allowing for intricate patterns to be marked on surfaces. However, a common challenge that most of these robotic systems faced is the integration of the marking mechanism (or plotter) with movement mechanism of the robot. Moreover, the available marking robots have limited drawing capabilities. Most of the available marking robots are bulky and/or can print in one color only. There are only a few robots that can draw numbers, letters, and simple symbols; however, the size of these prints is small. Furthermore, the available marking robots depend on CAD files, which may be helpful for space division purposes, but may add to complexity which may not be suitable for applications requiring a simpler planning method.

US20130310971A1 discloses a robotic apparatus for marking construction sites upon a floor surface. The robotic apparatus includes a base unit positioned at a reference point with storage for site layout information, a movable position locator that communicates with the base unit, and a robotic marker equipped with drive wheels and a spray means for marking. This reference does not mention a multi-axis plotter and ultrasonic sensors for autonomous marking, and has emphasis on the position locator for navigation.

U.S. Pat. No. 11,517,983B2 discloses a method for marking substrates through laser etching. The method involves designating a surface or portion of a substrate to receive marking, supporting the substrate, positioning a laser etching device, and actuating the device to laser etch desired indicia, particularly a dot pattern. This reference does not mention a multi-axis plotter and ultrasonic sensors, and focuses on laser etching and deformation detection of dot patterns.

US20210180346A1 discloses a topography marking system for marking construction information on surfaces. The system includes a rigid frame, a marking system with a spraying device and an engraving laser, and a topographic prism. The system can both spray a painting composition and burn it with the laser to mark construction information. This reference does not mention a multi-axis plotter and ultrasonic sensors, and is limited by its specific design for topographical marking with an emphasis on vertical alignment.

U.S. Pat. No. 7,294,204B2 discloses an apparatus for painting traffic marks on road surfaces. The apparatus includes a trailer unit with supports, a gantry unit with axial gantries that can move in defined directions, a jet unit with a nozzle for marking, and a control unit for operation. This reference does not mention a multi-axis plotter and ultrasonic sensors, and the disclosed apparatus is particularly designed for road surfaces and relies on a complex gantry system for movement.

US20070059098A1 discloses an automatic ground marking apparatus. The automatic ground marking apparatus includes a carriage that traverses the ground, a position determining system (like a laser-based device with a base station and reflector), and a processor that generates control signals. The carriage marks the ground as it moves, producing the desired sign. This reference does not mention a multi-axis plotter and ultrasonic sensors, and is dependent on a laser-based position determining system.

Non-patent reference titled “Mobile robot for marking free access floors at construction sites” (Tsuruta et al.) discloses an automated mobile robotic system for marking free access floors at construction sites. The system utilizes a mobile robot with a central marking device guided by a laser positioning unit to automatically mark positions on the floor, indicating future pedestal base locations. This reference does not mention a multi-axis plotter and ultrasonic sensors, and herein, in this system, the position of the mobile robot cannot be determined when occluded by obstacles such as columns or walls.

Non-patent reference titled “Development of a Multi-Layer Marking Toolkit for Layout-Printing Automation at Construction Sites” (Park et al.) discloses a multi-layer marking toolkit for enhancing construction quality. The multi-layer marking toolkit includes a mechanical unit which connects through Ethernet and is operated using a wireless joystick. This reference does not mention a multi-axis plotter and ultrasonic sensors, and relies primarily on manual operations.

Each of the aforementioned references suffers from one or more drawbacks hindering their adoption. Accordingly, it is one object of the present disclosure to provide a robotic system that can autonomously navigate for surface marking with high precision and efficiency. It is another object of the present disclosure to offer a robotic system that integrates advanced sensors and control mechanisms, ensuring consistent and accurate surface markings. The combined features and functionalities of the proposed robotic system aim to address existing challenges, offering a holistic solution for automated surface marking tasks.

### SUMMARY

In an exemplary embodiment, a robotic system for surface marking is provided. The robotic system includes a plotter configured to move along x, y, and z axes. The robotic system further includes a chassis configured to hold a plurality of components of the robotic system. The chassis comprises a first circular sheet having a square-shaped opening in a center of the first circular sheet and a second circular sheet mounted on top of the first circular sheet. The robotic system further includes one or more ultrasonic sensors mounted on a periphery of the chassis and configured to detect obstacles during movement of the robotic system. The robotic system further includes at least three drive members coupled to a motor unit configured to control the movement of the robotic system on a surface. The robotic system further includes a computer processor having program instructions for controlling the robotic system. Herein, the movement of the robotic system is controlled with the computer processor so as to move the plotter and form a marking on the surface based on a pre-determined surface marking stored in a memory of the computer processor.

In some embodiments, the plotter comprises a servo motor and at least two stepper motors.

In some embodiments, the at least two stepper motors are configured to move the plotter along the x and y axes.

In some embodiments, the servo motor is configured to move the plotter along the z axis. In some embodiments, the plotter further comprises an aluminum extrusion.

In some embodiments, the plotter is attached to the first circular sheet of the chassis using a pair of angle mounts.

In some embodiments, the second circular sheet of the chassis has a circular opening in a center of the second circular sheet.

In some embodiments, the second circular sheet of the chassis is mounted on top of the first circular sheet.

In some embodiments, the chassis comprises a u-channel.

In some embodiments, the at least three drive members comprises a triangular arrangement of at least one selected from three pairs of omnidirectional wheels and two differentially driven wheels with a castor wheel.

In some embodiments, the at least three drive members are connected to the first circular sheet of the chassis.

In some embodiments, a shaft is connected to the at least three drive members with a shaft coupler.

In some embodiments, a power unit is connected to a plurality of motors of the plotter and the motor unit.

In some embodiments, the motor unit comprises a microcontroller, a set of motors and encoders.

In some embodiments, the microcontroller is configured to communicate with a host computer.

In some embodiments, the computer processor comprises a user interface.

In some embodiments, the plotter is configured to move along the z axis for surface marking.

In another exemplary embodiment, a robot for surface marking is provided. The robot includes a plotter including a belt and pulley unit coupled to a pen. The robot further includes a chassis including a first circular sheet having a square-shaped opening in the center of the first circular sheet and a second circular sheet mounted on top of the first circular sheet. The robot further includes one or more ultrasonic sensors mounted on a periphery of the chassis. The robot further includes at least three drive members coupled to a motor unit. The robot further includes a computer processor having program instructions.

In some embodiments, the plotter further comprises at least one servo motor and a plurality of stepper motors.

In some embodiments, the robot further comprises a power unit and a microcontroller.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is a perspective view diagram of a robotic system, according to certain embodiments;

FIG. 1B is a wireframe diagram of the robotic system, according to certain embodiments;

FIG. 1C is a top perspective diagram of the robotic system without a second circular sheet thereof, showing an arrangement of components therein, according to certain embodiments;

FIG. 1D is a partial perspective diagram of the robotic system of FIG. 1C, depicting the arrangement of components therein in detail, according to certain embodiments;

FIG. 2A is a schematic block diagram illustrating connections between components of the robotic system, according to certain embodiments;

FIG. 2B is a circuit diagram illustrating electrical connections between the components of the robotic system, according to certain embodiments;

FIG. 3A is a simplified diagram of the robotic system depicting possible directions of movement thereof when utilizing two differentially driven wheels, according to certain embodiments;

FIG. 3B is a simplified diagram of the robotic system providing factors affecting directions of movement thereof when utilizing three pairs of omnidirectional wheels, according to certain embodiments;

FIG. 3C illustrates the robotic system of FIG. 3B, depicting exemplary directions of movement thereof for exemplary values of factors, according to certain embodiments;

FIG. 4 is a flow diagram depicting implementation of obstacle avoidance for the robotic system, according to certain embodiments;

FIG. 5A is a first exemplary user interface for controlling the robotic system, according to certain embodiments;

FIG. 5B is a second exemplary user interface for controlling the robotic system, according to certain embodiments;

FIG. 5C is a third exemplary user interface for controlling the robotic system, according to certain embodiments;

FIG. 5D is a fourth exemplary user interface for controlling the robotic system, according to certain embodiments;

FIG. 5E is a fifth exemplary user interface for controlling the robotic system of FIG. 1A, according to certain embodiments;

FIG. 6A is a perspective view diagram of a robotic system, according to a first alternate embodiment; and

FIG. 6B is a perspective view diagram of a robotic system, according to a second alternate embodiment.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

Aspects of this disclosure are directed to a robotic system, implemented in the form of a robot, designed for surface marking. The robotic system provides a comprehensive approach to surface marking, integrating advanced functionalities to ensure consistent and accurate surface markings. The present robotic system introduces significant enhancements in terms of efficiency, accuracy, and autonomous operation over existing technologies that cater to demands of surface marking. The present robotic system is not only capable of delivering intricate and precise markings but also of adapting to various surface conditions and challenges. The adaptability of the present robotic system ensures that it remains resilient to different needs and demands of surface marking.

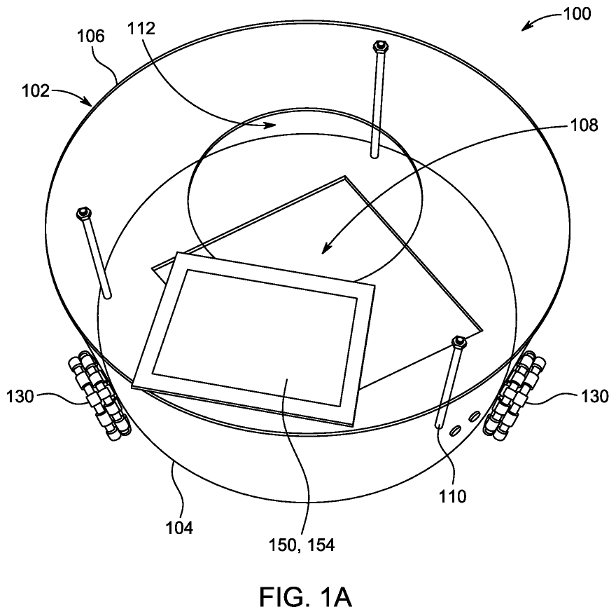

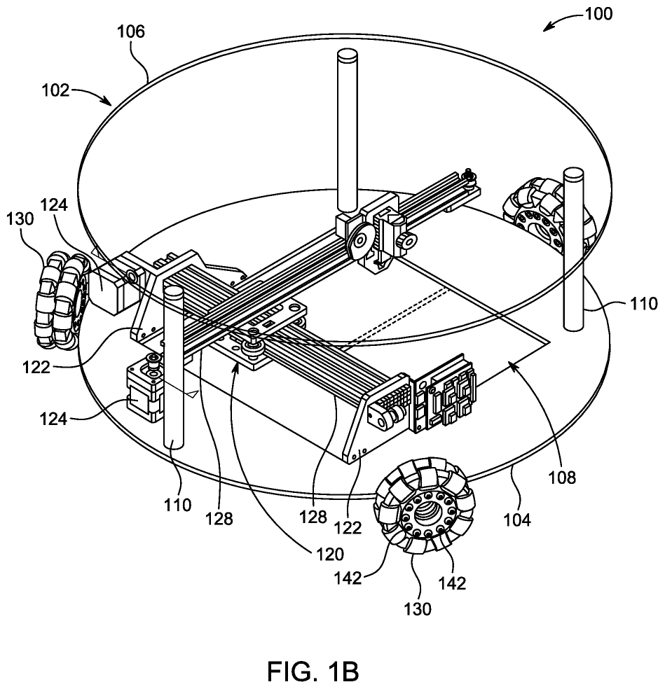

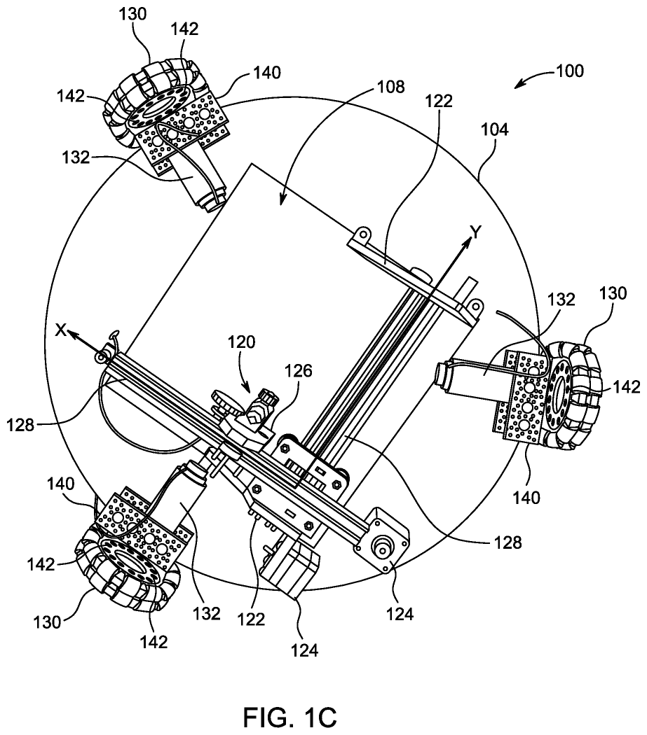

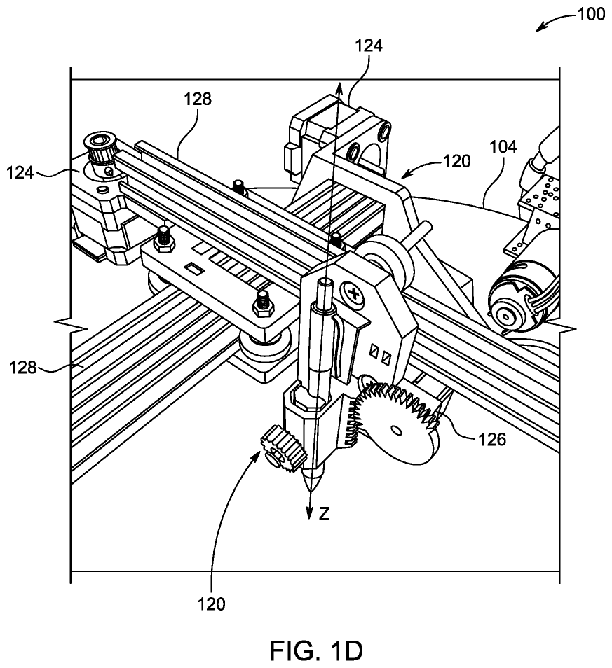

Referring to FIGS. 1A-1D, in combination, illustrated are different views of a robotic system 100 for surface marking, providing visual representations of the robotic system from various perspectives, including an understanding of its design and functionality. In the present embodiments, the robotic system 100 is implemented in the form of a robot. While the term “robotic system” highlights the collective constructive interaction of components and software working together for a specific purpose, the term “robot” typically refers to the physical embodiment of such system. The two terms have been interchangeably used hereinafter for purposes of the present disclosure, emphasizing that they refer to the same entity.

As illustrated, the robotic system 100 includes a chassis 102 configured to hold a plurality of components of the robotic system 100. The chassis 102 is designed accommodate and secure the various components involved in functioning of the robotic system 100. The design of the chassis 102 is adapted such that all integrated components are positioned to facilitate interaction and coordination among them. The chassis 102 helps in the overall stability and efficiency of the robotic system 100 by providing a robust and stable platform, ensuring that each component functions in harmony with the others, leading to optimal performance of the robotic system 100 for surface marking. In the illustrated examples of FIGS. 1A-1D, the chassis 102 is shown to be generally circular in design; however, it will be contemplated by a person skilled in the art that the chassis 102 may be adapted in other suitable shape, such as rectangular or the like (also discussed as alternate embodiments later in this description), without departing from the scope and the spirit of the present disclosure.

As better seen in FIG. 1B, the chassis 102 includes a first circular sheet 104 and a second circular sheet 106. Herein, the first circular sheet 104 has a polygonal, preferably square-shaped, or rectangular opening (as represented by reference numeral 108) in a center thereof. The square-shaped opening 108 is positioned at the center of the first circular sheet 104 (which may be a radial center of the first circular sheet 104), for potentially allowing for integration of additional modules or systems. The second circular sheet 106 of the chassis 102 is mounted on top of the first circular sheet 104. Herein, the second circular sheet 106 is positioned directly above the first circular sheet 104, ensuring an alignment between them. The placement of the second circular sheet 106 over the first circular sheet 104 creates a layered arrangement that enhances structural integrity of the chassis 102, and thereby stability of the robotic system 100. As shown, the second circular sheet 106 is separated from the first circular sheet 104 using spacers 110, in the form of pillars (three in number, but may be less or more depending on size, configuration, etc. of the chassis 102 without any limitations). Further, herein, sides of the chassis 102 may be covered by sheet material, such as carton or the like, without any limitations. Such configuration provides space in the chassis 102 between the first circular sheet 104 and the second circular sheet 106, for housing various components of the robotic system 100, as discussed in more detail in the proceeding paragraphs. In some examples, as shown in FIG. 1A, the second circular sheet 106 of the chassis 102 has a circular opening (as represented by reference numeral 112) in a center thereof (which may be a radial center of the second circular sheet 106 without any limitations). Due to the alignment of the first circular sheet 104 and the second circular sheet 106, the circular opening 112 in the second circular sheet 106 may facilitate access to underlying components placed on the first circular sheet 104, of the chassis 102, in the robotic system 100. In present examples, the first circular sheet 104 may be made of aluminum material or the like to allow for handling loads, while the second circular sheet 106 may be made of acrylic material or the like for aesthetic purposes. It may be appreciated by a person skilled in the art that sizes of the first circular sheet 104 and the second circular sheet 106, and the respective openings 108, 112 therein, may vary based on the configuration of the components to be supported by the chassis 102 in the robotic system 100.

In one embodiment, not shown FIG. 1A, each pillar includes a corresponding anchoring shaft which has a rod capable of extending below the first circular plate (104). Each anchoring shaft includes a retractable rod that can be extended to contact a surface on which a marking is to be made and retracted via a solenoid. The body of the anchoring shaft and associated solenoid is disposed mainly between the first (104) and second (102) circular sheets. Preferably the anchoring shaft extends below the first circular sheet only upon activation of the solenoid. Preferably all of the anchoring rods are configured to extend at the same time thereby providing positional stability. For example, after moving to a location for making a marking using the plotter, the robot may deploy (extend) the anchoring rods to secure the robot in position during operation of the plotter.

Also, as illustrated in FIGS. 1A-1D, the robotic system 100 includes a plotter 120 configured to move along x, y, and z axes. The plotter 120 plays a role in operational dynamics of the robotic system 100 due to its maneuverability along three distinct axes: x, y, and z. In particular, the plotter 120 has the capability to traverse horizontally across surfaces, represented by its movement along the x and y axes. Additionally, the ability of the plotter 120 to adjust vertically is facilitated by its movement along the z-axis. This multi-dimensional mobility of the plotter 120 not only enhances its versatility in marking operations but also ensures that the markings may be made with varying depth or intensity. By moving along these axes, the plotter 120 within the robotic system 100 may achieve precise and intricate markings, making the robotic system 100 suitable for different types (designs) of surface markings. It may be noted that although, in the exemplary illustrations, a pen has been shown as a marking instrument in the plotter 120; in other examples, other types of marking instruments, such as an inkjet printer, a sprayer, or the like may be used, without departing from the scope and the spirit of the present disclosure.

As shown, the plotter 120 is attached to the first circular sheet 104 of the chassis 102 using a pair of angle mounts 122. Specifically, the plotter 120 is disposed between the pair of angle mounts 122. Herein, each of the pair of angle mounts 122 may be located on opposing edges of the square-shaped opening 108 in the first circular sheet 104 of the chassis 102, such that the plotter 120 is generally located directly above the square-shaped opening 108 in the first circular sheet 104, so as to be able to access the surface for marking underneath thereof. The pair of angle mounts 122, in itself, may be fixed to the first circular sheet 104 using fasteners or the like. The pair of angle mounts 122 helps in ensuring stability of the plotter 120 during operations. By using the pair of angle mounts 122, the robotic system 100 ensures a balanced attachment, distributing weight of the plotter 120 evenly across the chassis 102. Moreover, the pair of angle mounts 122 offer flexibility in terms of adjustments, allowing for optimal alignment and positioning of the plotter 120 relative to the surface.

In some examples, the chassis 102 includes a u-channel (not shown). The u-channel is a structural component that is typically U-shaped in cross-section. The u-channel may be strategically positioned to offer direct or indirect support to the plotter 120. The design of the u-channel allows it to interface with parts of the plotter 120 or the components associated with it, ensuring that the plotter 120 remains firmly in place, especially during operation thereof. Such U-shaped design provides a natural recess, which can function as a guide or a resting point, potentially assisting in stabilizing the plotter 120, especially when it is maneuvering along the x, y, and z axes. The u-channel may also contribute to the overall structural rigidity of the chassis 102, ensuring that it remains stable during operations of the robotic system 100.

As best illustrated in FIGS. 1C and 1D, the plotter 120 includes a servo motor 124 and at least two stepper motors 126. In general, in the present configurations, the plotter 120 includes at least one servo motor 124 and a plurality of stepper motors 126. Herein, the at least two stepper motors 126 are configured to move the plotter 120 along the x and y axes. That is, the primary function of the stepper motors 126 within the robotic system 100 is to facilitate the movement of the plotter 120 along the x and y axes. These axes typically represent horizontal movements, allowing the plotter 120 to traverse left-right (x-axis) and forward-backward (y-axis) across a surface. These stepper motors 126, by their inherent design, can rotate in fixed steps, making them ideal for applications requiring controlled and consistent movements. Within the robotic system 100, the stepper motors 126 work in tandem, each controlling and driving movement of the plotter 120 along one of the two horizontal axes. The integration of at least two stepper motors 126 for this purpose allows the plotter 120 to achieve precise lateral movements. This dual-motor configuration ensures that the plotter 120 can navigate to any point on a surface (within limits of the plotter 120) by adjusting its x and y coordinates. Further, the plotter 120 is configured to move along the z axis for surface marking. Herein, the servo motor 124 is configured to move the plotter 120 along the z axis. That is, the servo motor 124 primarily caters to the vertical movements, allowing the plotter 120 to adjust its height or depth during the surface marking process. By precisely controlling distance of the plotter 120 from the surface, the robotic system 100 can ensure consistent depth and intensity of the surface markings. Furthermore, the feedback mechanism inherent to the servo motor 124 allows it to continually adjust positioning of the plotter 120 based on real-time feedback. This is especially required when marking surfaces that may not be entirely flat or when different depths of markings are required.

Also, as illustrated, the plotter 120 includes an aluminum extrusion 128. In particular, the plotter 120 includes two aluminum extrusions 128, placed orthogonal to each other along the x and y axes. The aluminum extrusions 128 serve as guide rails for the plotter 120, ensuring its smooth and linear movement along the specified axes. The plotter 120 may travel along the aluminum extrusions 128 to reach different positions across the surface underneath, for marking purposes. As may be seen, the plotter 120 is supported by one of the aluminum extrusions 128 by the pair of angle mounts 122 in the chassis 102. Thus, the aluminum extrusions 128 function as structural support for the plotter 120, while also ensuring that the weight of the plotter 120 is distributed evenly on the chassis 102. This even distribution of weight also ensures that the plotter 120 remains stable during its operations, preventing any wobbling or misalignment, which could affect the quality of the markings. Herein, aluminum material is used for these extrusions 128 due to its lightweight and durable properties. The use of aluminum for these extrusions 128 also offers advantage in terms of resistance to corrosion and wear.

In an embodiment, the robotic system 100, implemented as the robot 100, has the plotter 120 including a belt and pulley unit (not shown) coupled to a pen (as the marking instrument). The belt and pulley unit helps in the movement and control of the marking instrument, in this case, the pen. The belt and pulley unit is a well-known mechanism for transmitting rotational motion over a distance with minimal loss of power. In case of the plotter 120, the belt and pulley unit ensures that the pen can be moved smoothly and accurately across the surface. As the pulleys rotate, driven by, for example, the stepper motors 126, of the robot 100, the attached belt moves in tandem. This movement is then directly translated to the pen, allowing it to traverse the surface in a controlled manner. Further, in some cases, tension in the belt and pulley unit can be adjusted to ensure consistent contact between the pen and the surface. Moreover, design of the belt and pulley unit inherently absorbs minor vibrations or jitters, ensuring that movement of the pen remains smooth.

Again, referring to FIGS. 1A-1D, the robotic system 100 includes at least three drive members (each represented by reference numeral 130) coupled to a motor unit (not shown) configured to control the movement of the robotic system 100 on a surface. The drive members 130, in the form of wheels, provide the robotic system 100 with ability to navigate across various surfaces, ensuring it can effectively position itself for surface marking. The use of the at least three drive members 130 for the robotic system 100 helps with stability and precision. It may be appreciated that the precision of surface marking depends on the accuracy of the movement of the robot 100. Higher degree of maneuverability results in more precise movement. For instance, an omnidirectional robot can directly navigate sideway motion (i.e., to left or right directions). However, nonholonomic robots, like a car, may not allow for sideway motion, and may start to go into a trajectory to change its orientation to move the required sideway direction. Differential drive robot with two wheels may have slippage issues which cannot be counted by encoders, and may be required to take a longer path to the goal which means the errors will be greater. Thus, the present robot 100 with at least three drive members provides stability and precision. Further, with three points of contact on the surface, the robotic system 100 can maintain a balanced stance, reducing the chances of wobbling or tilting during operations.

In the present configuration, as shown, the at least three drive members 130 are connected to the first circular sheet 104 of the chassis 102. As discussed, the first circular sheet 104 is a primary structural component of the chassis 102, serving as a foundational base for various components of the robotic system 100. By affixing the drive members 130 to the first circular sheet 104, the robotic system 100 ensures a stable and robust platform for movement. This connection also ensures that the forces and torques generated by the drive members 130 during movement are evenly distributed across the chassis 102, preventing any undue stress or strain on individual components.

In example configurations, the at least three drive members 130 includes a triangular arrangement of at least one selected from three pairs of omnidirectional wheels and two differentially driven wheels with a castor wheel. Such triangular arrangement inherently offers a broad base of support, ensuring that the weight of the robotic system 100 is distributed across three primary points of contact with the surface. This distribution minimizes the risk of the system tilting or wobbling, especially during intricate surface marking operations or when navigating uneven terrains. As discussed, in this first example, each of the three drive members 130 in the triangular arrangement includes a pair of omnidirectional wheels. Omnidirectional wheels, as the name suggests, are specially designed wheels that can move in multiple directions without the need for axis of the wheel to change direction. This capability is achieved through a series of rollers mounted at an angle to main axis of the wheel. Herein, the use of omnidirectional wheels as the drive members 130 offers the robotic system 100 with ability to move forward, backward, side-to-side, and even diagonally without the need for complex turning maneuvers. This multidirectional movement capability ensures that the robotic system 100 can make sharp turns, as may be required for intricate surface marking operations. In the second example, the at least three drive members 130 includes a triangular arrangement of two differentially driven wheels with a castor wheel, as the drive members 130. Differentially driven wheels can be driven independently of one another. Each of these wheels is powered by its own motor, allowing it to rotate at a different speed or even in a different direction compared to the other. This independent control over the wheels grants the robotic system 100 a high degree of maneuverability. Further, the castor wheel is a pivoting wheel that automatically aligns itself to the direction of movement. In this arrangement, while the two differentially driven wheels manage primary propulsion and steering of the robotic system 100, the castor wheel offers support and stability to the robotic system 100. This arrangement with differential driving mechanism ensures that the robotic system 100 can make precise positional adjustments and alignments, which is important for tasks, such as surface marking.

Herein, at least in case of the drive members 130 having differential wheels, each of such drive members 130 may have its own dedicated motor 132 (as part of the motor unit), as shown in FIG. 1C. Having the dedicated motor 132 ensures that each such drive member 130 can be controlled separately, allowing it to rotate at different speeds or even in opposite directions compared to the others. This individual control provides the robotic system 100 with a high degree of agility. Furthermore, the inclusion of dedicated motors 132 for each drive member 130 ensures a consistent supply of power. This consistency provides each wheel with the necessary torque and rotational force required for its operations, ensuring uniformity in movement, and reducing the chances of one wheel lagging behind or moving faster than the others. On the other hand, as may be understood, in case of use of omnidirectional wheels as free wheels, these are preferably not mounted directly to a shaft of the motor unit. In the present examples, a shaft (not shown) is connected to the at least three drive members 130 with a shaft coupler (not shown). The primary function of the shaft coupler is to ensure a secure and efficient transfer of rotational movement from the shaft to the drive members 130. Furthermore, the shaft coupler provides flexibility in terms of adjustments and alignments, as it ensures that the shaft and the drive members 130 remain aligned, even if there are slight variations or misalignments in their positions.

Further, the robotic system 100 includes one or more ultrasonic sensors 140 mounted on a periphery of the chassis 102 and configured to detect obstacles during movement of the robotic system 100. The ultrasonic sensors 140 are strategically positioned on the periphery of the chassis 102, ensuring a broad field of detection around the robotic system 100. The ultrasonic sensors 140 function by emitting ultrasonic waves and then listening for their reflections or echoes. When these waves encounter an object or obstacle, they are reflected back and captured, and the time taken for the wave to travel out and return, coupled with the known speed of sound, allows the ultrasonic sensors 140 to calculate the distance to the obstacle. Herein, as illustrated, each of the drive members 130 is equipped with one of the ultrasonic sensors 140. Such configuration offers the robotic system, generally, with a 360-degree detection capability. In an example, a range of detection of the ultrasonic sensors 140 for the corresponding drive member 130 is about 2 to 450 cm. This comprehensive coverage ensures that obstacles, whether they are in front, behind, or to the sides of the robotic system 100, can be effectively identified. By detecting obstacles during the movement of the robotic system 100, potential collisions can be anticipated and avoided. Additionally, the data from the ultrasonic sensors 140 may be used to map the environment or create real-time navigation paths, allowing the robotic system 100 to determine the most efficient route for its operations.

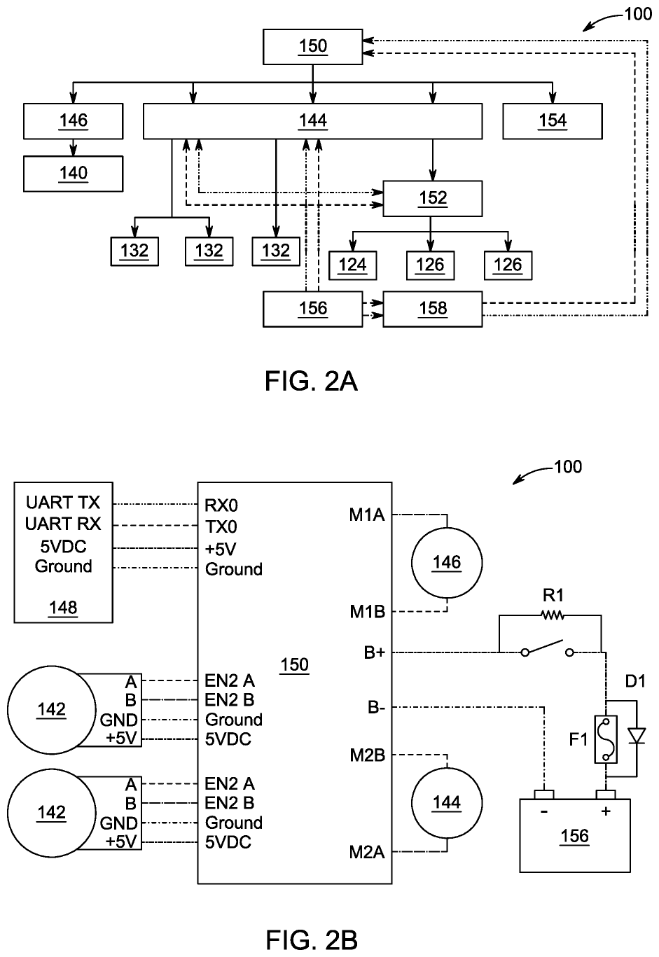

In some examples, the robotic system 100 further includes a power unit (shown in FIG. 2A, as represented by reference numeral 156). The power unit 156 is connected to the plurality of motors (including the servo motor 124 and the at least two stepper motors 126) of the plotter 120 and the motor unit (including the dedicated motors 132). The power unit 156 is configured to supply the requisite energy to these motorized elements of the robotic system 100. In an example, the power unit 156 may be in the form of a battery to allow for portability and free operation of the robotic system 100; however, in other examples, the power unit 156 may be in the form of a wired DC power source or the like, without any limitations. By design the power unit 156 ensures that, in the robotic system 100, the motorized elements, whether they are responsible for driving intricate movements of the plotter 120 or propelling the entire robot 100 across surfaces, receive a consistent and regulated flow of power.

Further, in some examples, the motor unit of the robotic system 100, includes a microcontroller (shown in FIG. 2A, and represented by reference numeral 144), a set of motors (including the motors 124, 126 and the dedicated motors 132) and encoders (as represented by reference numeral 142). Herein, the microcontroller 144 processes inputs, executes commands, and coordinates the actions of the motor unit. Specifically, the microcontroller 144 is responsible for interpreting instructions and translating them into tangible movements by sending directives to the associated motor. The set of motors 124, 126, 132, provide the mechanical force and rotation essential for driving the robotic system 100 and the plotter 120 therein, be it propelling the robot 100 across surfaces or enabling intricate maneuvers. The speed, direction, and duration of rotation are all governed by the commands from the microcontroller 144. The encoders 142 may continuously monitor and record the rotation, position, and speed of the set of motors 124, 126, 132. As the set of motors 124, 126, 132 operate, the encoders 142 generate data about their current status and relay this information back to the microcontroller 144. This feedback loop allows the microcontroller 144 to make real-time adjustments, ensuring that operations of the set of motors 124, 126, 132 align with the desired outcomes.

The robotic system 100 further includes a computer processor 150 having program instructions for controlling the robotic system 100. In an example, as illustrated in FIG. 1A, computer processor 150 may be implemented as a tablet or the like mounted on the chassis 102 of the robotic system 100. The computer processor 150 is configured to orchestrate various components of the robotic system 100 and ensure that they function harmoniously to achieve the desired tasks. The program instructions of a software control how the robotic system 100 should behave in different scenarios, guiding its movements. Integral to the computer processor 150 is a memory (not shown) that stores pre-determined surface markings. Herein, the movement of the robotic system 100 is controlled with the computer processor 150 so as to move the plotter 120 and form a marking on the surface based on the pre-determined surface marking stored in the memory of the computer processor 150. When the robotic system 100 is tasked with surface marking, the computer processor 150 references these stored designs in the memory. Using the program instructions and the stored marking design as a guide, the computer processor 150 orchestrates the movement of the robotic system 100, by controlling the drive members 130 and directing the plotter 120 to accurately replicate the desired surface marking.

Referring to FIG. 2A, illustrated is a schematic block diagram illustrating connections between the components of the robotic system 100. Further, FIG. 2B provides electrical connection of the microcontrollers, motors, and encoders, as discussed hereinafter. As shown, the computer processor 150, which may be a Raspberry Pi®, also known as RPI (with these terms being interchangeably used) or the like, may be responsible for orchestrating various components and ensuring that they function harmoniously to achieve the desired tasks. Given performance considerations, the model of the RPI 150 is selected to be Raspberry Pi 4B with a RAM of 4 GB, which supports multiple USB connections, offering four ports, ideal for interfacing with various controllers. Enhancing its computational capabilities, the RPI 150 operates on Ubuntu MATE. In present configuration, the computer processor 150 also acts as a host computer (with two terms being interchangeably used) to provide instructions to other controllers in the robotic system 100; however, in other examples, the host computer may be a separate computer, such as a PC. Herein, the microcontroller 144 is configured to communicate with the host computer 150. In an example, to manage these bidirectional data flows, Robot Operating System (ROS) is employed. The microcontroller 144, being responsible for the motors 132 (which may be DC brushed motors), may be implemented as RoboClaw 2X30A, which is a controller well-known in the art and suitable for the current requirements. This microcontroller 144 has in-built PID controller to provide precise motor control. Moreover, this microcontroller 144 comes equipped with a suite of programming libraries, compatible with both Python and Arduino platforms, enabling versatile command dispatch to the motors 132. Further, the microcontroller 144 interfaces with a CNC shield (represented by reference numeral 152), a specialized component that facilitates precise control over motors, especially in CNC (Computer Numerical Control) applications, for controlling the servo motor 124 and the two stepper motors 126. In some examples, the two stepper motors 126 may be controlled by respective motor drivers (not shown) which serve as intermediaries between the stepper motors 126 and the microcontroller 144, converting digital commands from the microcontroller 144 into analog signals that control speed, direction, and duration of operation of the two stepper motors 126. Further, the robotic system 100 includes a microcontroller 146, implemented as an Arduino® board, for controlling and processing data related to the ultrasonic sensors 140. As discussed, the ultrasonic sensors 140 provide real-time distance measurements, allowing the robotic system 100 to effectively navigate its environment, avoid obstacles, and make informed decisions about its path. In the present configuration, Arduino Uno, which serves as a hosting platform for the ultrasonic sensors 140, is interfaced with the RPI 150 leveraging ‘Firmata’ protocol. This protocol facilitates a streamlined communication pathway between microcontroller 146 and the host computer 150. The integration of the Firmata library on the microcontroller 146 allows for serial communication between the microcontroller 146 and the RPI 150. To further enhance this communication, the RPI 150 utilizes the ‘pymata4’ software library, rooted in the Firmata protocol and offering an interface for the RPI 150 to establish communication channels and dispatch commands, all scripted in Python. This setup ensures that commands and data can be exchanged effortlessly between the RPI 150 and the microcontroller 146, maximizing the efficiency and responsiveness of the robotic system 100. Also, as illustrated, the robotic system 100 further includes a display screen 154 (which may be part of a device incorporating the computer processor 150, as shown in FIG. 1A). The display screen 154 may provide real-time data, system status, or even allow users to input commands directly. For this purpose, the display screen 154 may provide a user interface (as discussed later) for a user to control the robotic system 100. Herein, all the electronic boards are connected to the RPI 150 via USB. The RPI 150 may be connected to the power unit 156 (such as, a battery) through a voltage regulator 158. The voltage regulator 158 may convert 12 V of the battery to 5V for supplying power to the various components. Such electrical connections along with the modular design, the interplay of various components, ensures that robotic system 100 achieves optimal performance.

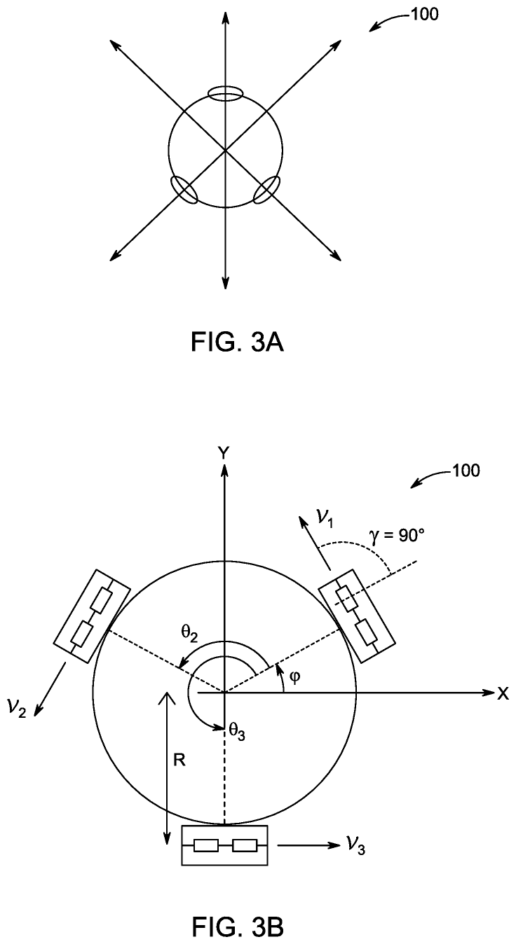

Within the design considerations of the robotic system 100, the selection of the motors 132 for the drive member 130 is driven by specific requirements and operational parameters. The motors 132, with unique attributes such as operating voltage and torque, are chosen based on an evaluation of expected needs of the robotic system 100. Foremost among these considerations is the anticipated load-bearing capacity. The robotic system 100 is designed to support a total weight of approximately 6 kg. This estimate arises from the aggregate weight of several components. The operational duration of the motors 132 is capped, ensuring they function continuously for no longer than a minute. Such a duration suffices for intended movements of the robotic system 100 between adjacent cells. In terms of speed, the motors 132 are calibrated to achieve a modest velocity of approximately 0.3 m/s. This deliberate moderation in speed provides precision, ensuring the robotic system 100 remains accurate during its operations and consistently aligns with its target pose. The design of the drive members 130, with a radius of 12 cm, is deliberately chosen to ensure the pen, integral to the plotter 120, seamlessly reaches the ground. Thereby, the requisite torque for operations of the robotic system 100 is determined to be approximately 0.98 Nm. It may be noted that these torque calculations are based on ability of the robotic system 100 to move directionally using only two powered drive members 130, as illustrated in FIG. 3A. This foundational assumption provides that if two of the dedicated motors 132 satisfactorily deliver the needed torque, third of the dedicated motors 132, when introduced, would be able to provide such capability. Herein, the desired wheel angular velocity stands at 47.77 revolutions per minute. In alignment with these specifications, the motors 132 are chosen as DC brushed motors, further enhanced with encoders 142 (such as, magnetic encoders). Further, the inherent angular velocity is rated at 165 rpm, introducing an added layer of operational safety to the robotic system 100.

In the development of the robotic system 100, ensuring the optimal performance and safety of the stepper motors 126 (specifically A4988), is achieved by tuning to manage and limit the current supplied to the stepper motors 126. This tuning is guided by the specific specifications provided for the stepper motors 126. To determine the appropriate current limit, the reference voltage (V_{ref}) is calculated based on the following equation:

$${V}_{ref} = 8 \times {I}_{max} \times {R}_{s}$$

wherein, V_{ref} represents the sense resistance, as indicated on the driver; Iₘₐₓ denotes the rated current of the stepper driver. By using the provided values:

$${V}_{ref} = 1.5 \times 8 \times 0.2 = 2.4 V$$

However, a practical consideration arises with motor drivers for the stepper motors 126. The maximum adjustable voltage it permits is capped at 1.6 V. This translates to a resultant current of 1 A, which, notably, is lower than the rated current. This reduced current signifies a more conservative and safer operational parameter for the stepper motors 126. The intrinsic benefit of operating below the rated current is the enhanced safety margin, ensuring that the stepper motors 126 may not overheat or overstrain.

Further, the mobility of the robotic system 100 is based on a kinematic model tailored for an omnidirectional vehicle equipped with three drive members 130. This configuration is illustrated in FIG. 3B. It may be appreciated that in case of wheeled robots, it is a standard practice to primarily focus on the kinematic model, bypassing the dynamic model, which is given as:

$$( \begin{matrix}{v}_{1} \\ {v}_{2} \\ {v}_{3}\end{matrix} ) = ( \begin{matrix}- sin ( φ ) & cos ( φ ) & R \\ - sin ( φ + {θ}_{2} ) & cos ( φ + {θ}_{2} ) & R \\ - sin ( φ + {θ}_{3} ) & cos ( φ + {θ}_{3} ) & R\end{matrix} ) ( \begin{matrix}\dot{x} \\ \dot{y} \\ \dot{φ}\end{matrix} )$$

The kinematic representation for the robotic system 100 incorporates various parameters, including v which signifies the linear speed, while x and y demarcate the speeds along the x and y-axes, respectively. Additionally, j stands for the rotational speed. This intricate correlation between these parameters is further depicted in FIG. 3C, which provides a graphic illustration of angles and their associated directions for the robotic system 100. In such case, the kinematic model is further translated into a mathematical equation as:

$$( \begin{matrix}\dot{x} \\ \dot{y} \\ \dot{φ}\end{matrix} ) = \frac{1}{3} ( \begin{matrix}0 & - \sqrt{3} & \sqrt{3} \\ 2 & - 1 & - 1 \\ 1 & 1 & 1 \\ \overline{27.5} & \overline{27.5} & \overline{27.5}\end{matrix} ) ( \begin{matrix}{v}_{1} \\ {v}_{2} \\ {v}_{3}\end{matrix} )$$

For effective navigation, the robotic system 100 is programmed using Python, specifically dispatching commands to the motion controllers. At the core of this programming is RoboClaw® library. This library is equipped with a function for directing the wheels towards predefined quadrates at defined speeds. It may be noted that these quadrates are intrinsically linked to readings of the encoders 142, translating motion into countable events. Given that operations of the robotic system 100 predominantly include short-distance maneuvers, the speed is consistently maintained at a lower, fixed rate. The aforementioned kinematic model is algorithmically encoded to compute the requisite encoder counts, ensuring the robotic system 100 reaches its intended position.

In particular, herein, the motion strategy is conceptualized as a series of transitions from one cell to another within a grid framework. Each of these cells spans dimensions of 20×10 cm. Consequently, the approach towards obstacle avoidance is conceptualized as bypassing an entire cell. The Python-based motion planning integrates several key functions, including a function that translates encoder pulses into distances; dedicated functions facilitating straight-line movements and rotational turns; an obstacle avoidance function predominantly relying on readings of the ultrasonic sensors 140 especially in direction of movement of the robotic system 100 (as discussed in detail in the following paragraph); and a function to move in a grid.

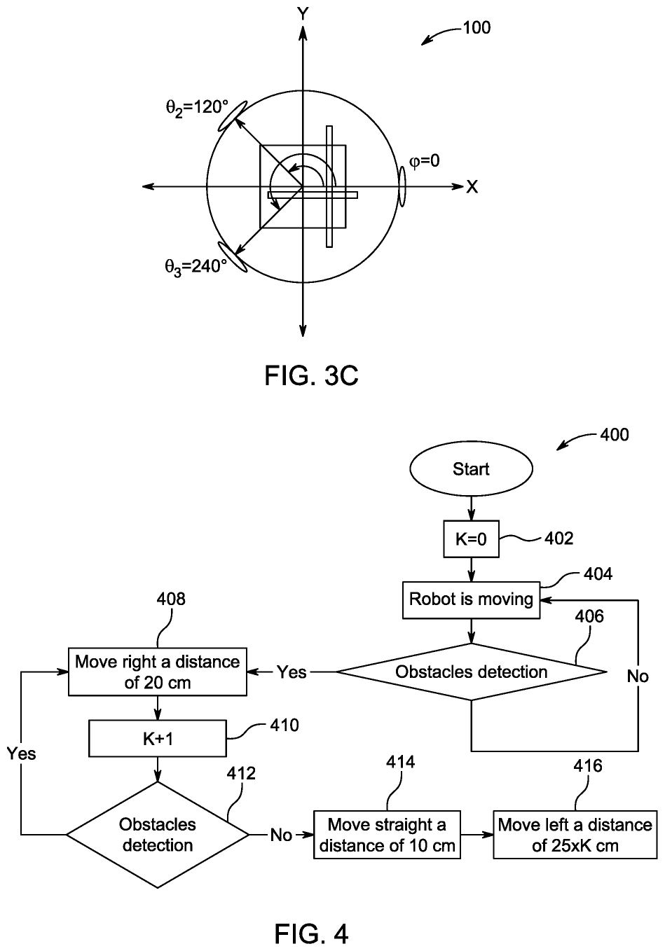

Herein, the obstacle avoidance algorithm ensures that the robotic system 100 can navigate its environment without colliding with any obstructions in its path. The procedure is outlined in a flowchart 400 of FIG. 4. The algorithm starts with the robot 100 at K=0 (as represented in block 402), where ‘K’ represents a grid along path of the robot 100. At block 404, the robot 100 commences its movement. At block 406, the algorithm involves obstacle detection. That is, as the robot 100 progresses, it actively scans for any obstacles in its immediate trajectory. If there are no obstacles (No), the robot 100 keeps moving. If there are obstacles (Yes), i.e., upon detecting an obstacle, at block 408, an immediate response of the robot 100 is to sidestep the obstruction by moving 20 cm to the right. Thereby, the robot 100 is at grid ‘K+1’ (as represented in block 410). At block 412, the robot 100 once again checks for obstacles. If ‘Yes,’ i.e., obstruction(s) is detected, then the process moves back to the block 408. If ‘No,’ i.e., there are no further obstructions detected, the process proceeds to block 414 where the robot 100 advances straight ahead, covering a distance of 10 cm. Further, at block 416, the robot 100 moves to the left, by shifting a distance of 25×K cm. This algorithm ensures that the robot 100 has a set of standardized responses to obstacles, allowing it to navigate complex environments with a degree of predictability and safety. By first moving right, then advancing forward, and finally shifting left (if needed) by a variable distance, the robot 100 is able to manage a wide array of obstructions, ensuring smooth and uninterrupted operation.

In present examples, for generating surface markings, CNC (Computer Numerical Control) machines-based control may be used. Central to CNC machining is the conversion of designs or images into a format known as G-code. This format essentially deciphers the design into movement instructions, outlining the path and actions necessary for realizing the design. To operationalize this G-code, it is dispatched to the Arduino board, either directly through coding or via software programs. While there are multiple such software programs, notable ones include Candle, Universal G-code Sender (UGS), and Lightburn. It may be appreciated that Lightburn software, traditionally used for laser engraving machines, is employed for both testing the plotter 120 and generating the requisite G-code. However, given the difference in machinery, the G-code from Lightburn needs adjustments to cater to a marking instrument of the plotter 120. Such modification involves reversing commands that control vertical movements of the marking instrument. Once refined, the G-code is dispatched using a Python script. This script initiates serial communication, sequentially sending the G-code. This Python code has undergone modifications to ensure optimal performance with the robotic system 100.

Herein, the microcontroller 144 acts as the intermediary between the host computer 150 and the motors 124, 126, 132. The microcontroller 144 translates the G-code instructions into tangible motor movements. In this context, GRBL is used as the firmware, specifically tailored for motion control. Multiple versions of GRBL exist, but given the specific requirement of controlling the Z-axis with the servo motor 124, the grbl-servo package is employed. Herein, GRBL's configuration necessitates tuning specific parameters tailored to the plotter 120, including for the ‘steps per mm’ and ‘max travel’. While the former defines the number of pulses the robotic system 100 requires moving an axis by one millimeter, the latter sets the boundary for the maximum distance an axis can traverse. The ‘steps per mm’ is influenced by several factors, including the belt type, pulley teeth, motor characteristics, and micro step value of the servo motor 124. For the x and y axes, this is mathematically represented as:

Steps/mm=pulley tooth×micro stepping/belt pitch×Steps per turn

Given the values:

$$Steps / mm = 200 \times 16 / 16 \times 2 = 100$$

Herein, the ‘max travel’ parameter, although set to the axis's full length, is chosen to be shorter, acting as a safeguard. This precaution arises from the robot 100 tendency to occasionally skip steps, risking overshooting its limits. Therefore, the x and y axes' maximum travel are conservatively set at 20×10 cm.

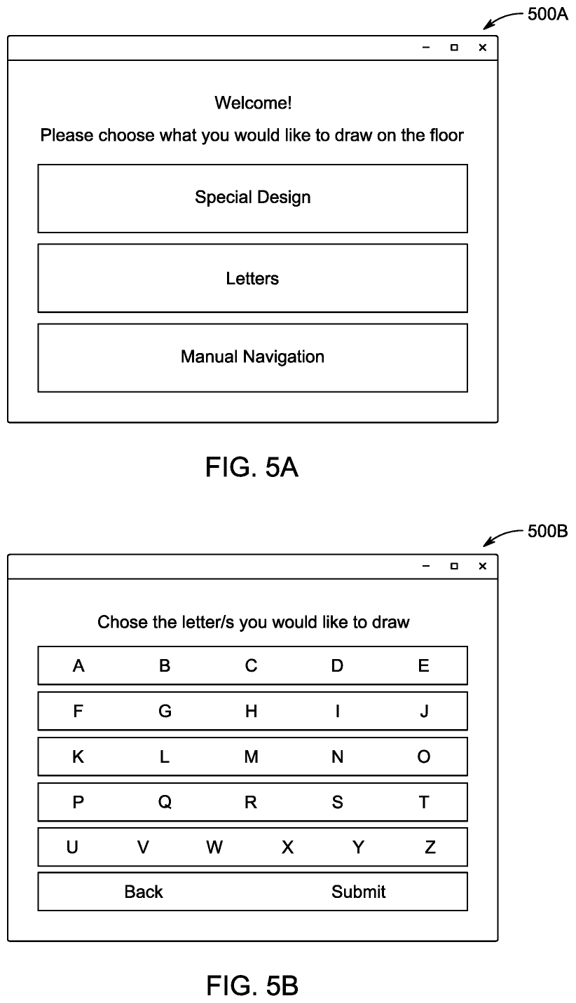

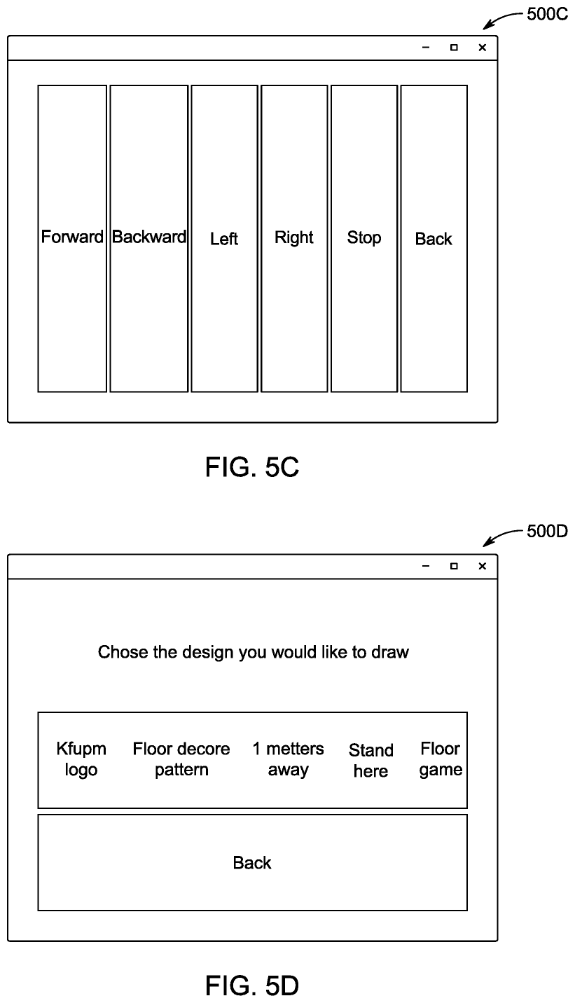

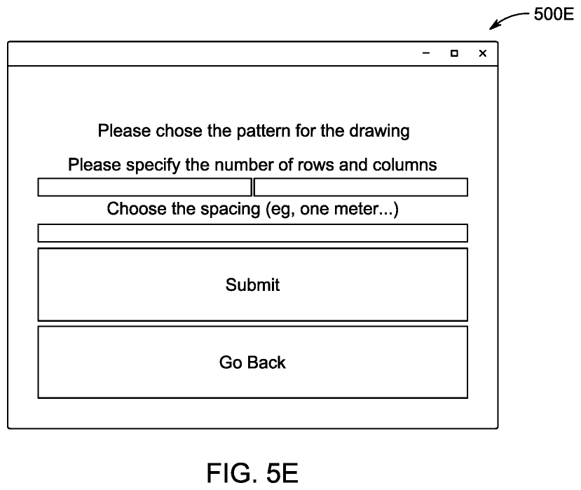

Referring now to FIGS. 5A-5E, in the present configuration, the computer processor 150 includes a user interface (as represented by reference numerals 500A-500E). In present examples, the user interfaces 500A-500E are designed utilizing the capabilities of the kivy library, an open-source library with multiple utility features. The user interface 500A, as depicted in FIG. 5A, serves as a welcome window, which provides an introductory dashboard, outlining various available actions to the user. The user interface 500B, as illustrated in FIG. 5B, provides a letters window specifically focuses on letters, offering functionalities related to textual inputs or typography preferences. The user interface 500C, as illustrated in FIG. 5C, provides a navigation window, enabling users to manually navigate through functionalities or the design space offered by the robotic system 100. The user interface 500D, as illustrated in FIG. 5D, provides a designs window, which provides users with an array of design choices or templates, potentially allowing them to customize or select specific graphical elements. The user interface 500E, as illustrated in FIG. 5E, provides a pattern window, which may include a variety of patterns, textures, or repetitive designs, offering further customization avenues to users. Further details may be understood from the illustrations and have not been repeated herein for brevity of the present disclosure.

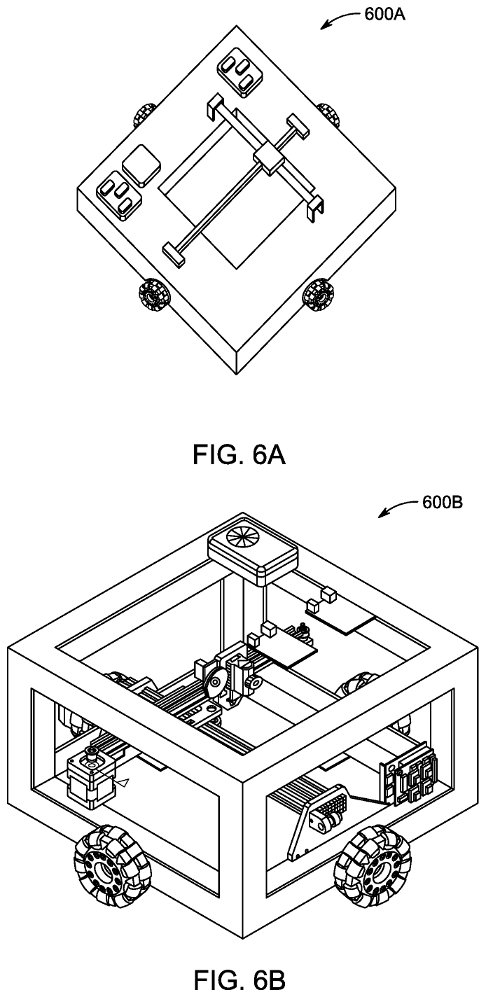

Further referring to the accompanying illustrations, FIG. 6A presents a perspective view of a robotic system 600A as per a first alternate embodiment. As may be seen, the robotic system 600A implements a “squarish” design (instead of circular design of the robotic system 100) of about 40 cm×40 cm with square-shaped opening for accommodating the plotter having length of about 20 cm. It may be appreciated that the robotic system 600A depicts a variant design, configuration, or feature set, providing insights into the adaptability and versatility of design of the present system. Similarly, FIG. 6B offers a perspective view of a robotic system 600B, as per a second alternate embodiment. The robotic system 600B highlights yet another distinct design or set of features, emphasizing the capacity for modifications or enhancements, tailored to specific applications or requirements. These alternate embodiments highlight the inherent flexibility and modularity of the robotic system as per embodiments of the present disclosure, catering to diverse operational needs or scenarios.

The robotic system 100 of the present disclosure is designed to cater to precise marking needs on various surfaces. The robotic system 100 represents a significant advancement in the realm of autonomous surface marking. Through its unique combination of components and features, the robotic system 100 provides precision, efficiency, and versatility in surface marking applications. The robotic system 100 operational dynamics, as governed by the computer processor 150, loaded with program instructions that guide its movements and marking activities, ensures reproducibility and standardization in marking tasks.

Owing to the motor unit, the robotic system 100 can execute precise and controlled movements. The ability of the plotter 120 to move along the x, y, and z axes, coupled with its integration with the computer processor 150, enables the robotic system 100 to produce detailed surface markings. The design of the robotic system 100, which factors in the use of a kinematic model, ensures optimal movement patterns, especially when transitioning between distinct cells or sections. This ensures that the surface markings are accurate and consistent with the pre-determined design. The incorporation of at least three drive members, whether in the form of omnidirectional wheels or differentially driven wheels coupled with a castor wheel, provides the robotic system 100 with the capability to navigate various surface conditions. The presence of ultrasonic sensors allows the robotic system 100 to detect obstacles during its movement, which enhances safety and ensures uninterrupted operations. Further, the user interfaces 500A-500E provide an intuitive platform for users to interact with the robotic system 100, streamlining operations and enhancing user experience.

Numerous modifications and variations of the present disclosure are possible in light of the above teachings. It is therefore to be understood that within the scope of the appended claims, the present invention may be practiced otherwise than as specifically described herein.

1. A robotic system for surface marking, comprising:
a plotter configured to move along x, y, and z axes;
a chassis configured to hold a plurality of components of the robotic system, wherein the chassis comprises a first circular sheet having a square-shaped opening in a center of the first circular sheet and a second circular sheet mounted on top of the first circular sheet;
one or more ultrasonic sensors mounted on a periphery of the chassis and configured to detect obstacles during movement of the robotic system;
at least three drive members coupled to a motor unit configured to control the movement of the robotic system on a surface; and
a computer processor having program instructions for controlling the robotic system,
wherein the movement of the robotic system is controlled with the computer processor so as to move the plotter and form a marking on the surface based on a pre-determined surface marking stored in a memory of the computer processor.

2. The robotic system of claim 1, wherein the plotter comprises a servo motor and at least two stepper motors.

3. The robotic system of claim 2, wherein the at least two stepper motors are configured to move the plotter along the x and y axes.

4. The robotic system of claim 2, wherein the servo motor is configured to move the plotter along the z axis.

5. The robotic system of claim 1, wherein the plotter further comprises an aluminum extrusion.

6. The robotic system of claim 1, wherein the plotter is attached to the first circular sheet of the chassis using a pair of angle mounts.

7. The robotic system of claim 1, wherein the second circular sheet of the chassis has a circular opening in a center of the second circular sheet.

8. The robotic system of claim 1, wherein the second circular sheet of the chassis is mounted on top of the first circular sheet.

9. The robotic system of claim 1, wherein the chassis comprises a u-channel.

10. The robotic system of claim 1, wherein the at least three drive members comprises a triangular arrangement of at least one selected from three pairs of omnidirectional wheels and two differentially driven wheels with a castor wheel.

11. The robotic system of claim 1, wherein the at least three drive members are connected to the first circular sheet of the chassis.

12. The robotic system of claim 1, wherein a shaft is connected to the at least three drive members with a shaft coupler.

13. The robotic system of claim 1, wherein a power unit is connected to a plurality of motors of the plotter and the motor unit.

14. The robotic system of claim 1, wherein the motor unit comprises a microcontroller, a set of motors and encoders.

15. The robotic system of claim 14, wherein the microcontroller is configured to communicate with a host computer.

16. The robotic system of claim 1, wherein the computer processor comprises a user interface.

17. The robotic system of claim 1, wherein the plotter is configured to move along the z axis for surface marking.

18. A robot for surface marking, comprising:
a plotter including a belt and pulley unit coupled to a pen;
a chassis including a first circular sheet having a square-shaped opening in the center of the first circular sheet and a second circular sheet mounted on top of the first circular sheet;
one or more ultrasonic sensors mounted on a periphery of the chassis;
at least three drive members coupled to a motor unit; and
a computer processor having program instructions.

19. The robot of claim 18, wherein the plotter further comprises at least one servo motor and a plurality of stepper motors.

20. The robot of claim 18, wherein the robot further comprises a power unit and a microcontroller.
